(19) United States
(12) Patent Application Publication
(10) Pub. No.: US 2022/0356107 A1
(43) Pub. Date: Nov. 10, 2022

(54) METHOD FOR PRODUCING GLASS FILAMENT

(71) Applicants: SHIN-ETSU CHEMICAL CO., LTD., Tokyo (JP); SHINSHU UNIVERSITY, Matsumoto City (JP)

(72) Inventors: Yusuke TAGUCHI, Annaka-shi (JP); Hiroyuki FUKASAWA, Annaka-shi (JP); Toshio SHIOBARA, Tokyo (JP); Yuta TAKAHASHI, Ueda City (JP); Toshifumi IKAGA, Ueda City (JP); KyoungHou KIM, Ueda City (JP); Yutaka OHKOSHI, Ueda City (JP)

(73) Assignees: SHIN-ETSU CHEMICAL CO., LTD., Tokyo (JP); SHINSHU UNIVERSITY, Matsumoto City (JP)

(21) Appl. No.: 17/732,612

(22) Filed: Apr. 29, 2022

(30) Foreign Application Priority Data
May 10, 2021 (JP) 2021-079801

(51) Int. Cl. C03B 37/025; C03C 3/06

(52) U.S. Cl. CPC C03B 37/025; C03C 3/06

(57) ABSTRACT

A method for producing a glass filament, the method including: irradiating a raw yarn containing 70 wt % or more of SiO₂ and having a raw yarn diameter of 100 to 2,000 μm with laser light having a wavelength of 0.7 to 100 μm to heat the raw yarn; and stretching the raw yarn to obtain the glass filament having a hydroxyl group (Si—OH) content of 300 ppm or less and a diameter of 1 to 20 μm.

### CROSS-REFERENCE TO RELATED APPLICATION

This non-provisional application claims priority under 35 U.S.C. § 119(a) on Patent Application No. 2021-079801 filed in Japan on May 10, 2021, the entire contents of which are hereby incorporated by reference.

### TECHNICAL FIELD

The present invention relates to a method for producing a glass filament, and more specifically, to a method for producing an extra-fine glass filament having a small hydroxyl group content.

### BACKGROUND ART

In recent years, the spread of the fifth generation mobile communication system (5G) and the development and production of IoT devices are in progress, and a highly functional printed wiring board capable of coping with high-speed information processing and high frequency communication is required. Therefore, glass cloth for printed wiring boards is required to have a low dielectric loss for further suppressing signal deterioration.

It is known that glass fibers having a higher SiO₂ content than that of general glass fibers have excellent dielectric properties. In particular, quartz glass fibers made of SiO₂ and having high purity have a small relative permittivity and a small dielectric loss tangent, and therefore have a very small dielectric loss, and are expected to be widely used as glass cloth for printed wiring boards.

It has been reported that a quartz glass filament can be produced by heating a quartz glass rod to about 2,000° C. and stretching the quartz glass rod (Patent Document 1). In this producing method, an extra-fine quartz glass rod is heated by an oxyhydrogen flame burner and stretched, but hydroxyl groups increase due to moisture generated by oxyhydrogen flame, which causes a problem that the dielectric loss of the obtained quartz glass filament increases.

### CITATION LIST

Patent Document 1: JP-A 2006-28240

Patent Document 2: JP-A S58-55349

Patent Document 3: US Patent Application No. 3981705

Patent Document 4: JP 4748513

### SUMMARY OF THE INVENTION

The present invention has been made in view of the above circumstances, and an object thereof is to provide a method for producing an extra-fine glass filament having a small hydroxyl group content and a small dielectric loss.

As a result of intensive studies to achieve the above object, the present inventors have found that, by applying a heating-stretching technique using laser light irradiation to a glass raw yarn having a high SiO₂ content, an increase in hydroxyl groups in a stretching step is prevented, and an extra-fine glass filament having a small dielectric loss is obtained, thereby completing the present invention.

The technique for irradiation of optical glass fibers with laser light has been known from long ago. For example, Patent Document 2 discloses that a joint portion is irradiated with laser light. Patent Document 3 discloses that precise diameter control of glass fibers for an optical waveguide is enabled by laser light irradiation, but this is not a technique for performing laser light irradiation for heating and stretching in glass filament production.

Patent Document 4 discloses a technique for producing extra-fine fibers by irradiating an organic resin with laser light, but Patent Document 4 discloses the application of the laser light to the organic substance, and does not disclose laser light irradiation for heating and stretching in production of a glass filament made of an inorganic substance.

That is, the present invention provides:

1. A method for producing a glass filament, the method comprising: irradiating a raw yarn containing 70 wt % or more of SiO₂ and having a raw yarn diameter of 100 to 2,000 μm with laser light having a wavelength of 0.7 to 100 μm to heat the raw yarn; and stretching the raw yarn to obtain a glass filament having a hydroxyl group (Si—OH) content of 300 ppm or less and a diameter of 1 to 20 μm;
2. The method for producing a glass filament according to 1, wherein a laser source of the laser light is selected from carbon dioxide, YAG, Nd/glass, Nd/vanadate, diode, fiber, disk, HeCd, copper vapor laser, iodine laser, argon laser, krypton laser, and chemical laser,
3. The method for producing a glass filament according to 1 or 2, wherein the raw yarn is made of quartz glass containing 99 wt % or more of SiO₂:
4. The method for producing a glass filament according to 3, wherein the raw yarn is irradiated with carbon dioxide laser to heat the raw yarn to a temperature of 1,700° C. or higher, and stretched; and
5. The method for producing a glass filament according to 3 or 4, wherein the raw yarn is irradiated with carbon dioxide laser to heat the raw yarn, and stretched at a ratio of 1,000 times or more to obtain the glass filament having a diameter of 3 to 10 μm.

### Advantageous Effects of Invention

In the method for producing a glass filament of the present invention, heating and stretching are performed by laser light irradiation, and therefore even a glass species having a high SiO₂ content, in which dielectric loss characteristics are deteriorated due to an increase in hydroxyl groups in conventional heating and stretching using an oxyhydrogen flame, can prevent an increase in hydroxyl groups in a stretching step, and as a result, a glass filament having a small number of hydroxyl groups and a small dielectric loss can be obtained.

The production method of the present invention has more excellent productivity and economic efficiency than those of a production method in which all steps are performed by heating in an electric furnace, and has a small thermal history during stretching, so that the amount of strain of the surface of the glass filament is small, which makes it possible to suppress a decrease in the strength of the obtained glass filament.

The glass filament containing 70 wt % or more of SiO₂, obtained by the production method of the present invention has excellent dielectric properties, and in particular, the glass filament made of high-purity quartz glass having a SiO₂ content of 99 wt % or more has more excellent heat resistance, weather resistance, thermal shock resistance, chemical stability, low thermal expansion coefficient, and electrical properties and the like.

### BRIEF DESCRIPTION OF THE DRAWINGS

FIG. 1 is a schematic side view illustrating an example of a glass filament stretching apparatus used in a method for producing a glass filament of the present invention; and

FIG. 2 is a schematic side view illustrating an irradiating/heating means for irradiating a raw yarn with laser light to heat the raw yarn, included in the glass filament stretching apparatus of FIG. 1.

### DESCRIPTION OF THE PREFERRED EMBODIMENT

Hereinafter, the present invention is described in more detail.

A method for producing a glass filament of the present invention includes: irradiating a raw yarn containing 70 wt % or more of SiO₂ and having a raw yarn diameter of 100 to 2,000 μm with laser light having a wavelength of 0.7 to 100 μm to heat the raw yarn; and stretching the raw yarn to obtain a glass filament having a hydroxyl group (Si—OH) content of 300 ppm or less and a diameter of 1 to 20 μm.

### [1] Raw Material Glass

Raw material glass constituting the raw yarn used in the method for producing a glass filament of the present invention is glass containing 70 wt % or more of SiO₂ and having an excellent low dielectric loss, and examples thereof include D glass containing B₂O₃ or other metal oxides with a SiO₂ content of 72 wt %, quartz glass having a SiO₂ content of 90 wt % or more, and high purity quartz glass having a SiO₂ content of 99 wt % or more.

In general, the dielectric loss is improved as the SiO₂ content increases, whereby the raw material glass used in the present invention is preferably quartz glass having a SiO₂ content of 90 wt % or more, and more preferably high-purity quartz glass having a SiO₂ content of 99 wt % or more.

### [2] Raw Yarn

The raw yarn used in the production method of the present invention has a diameter of 100 to 2,000 μm.

This raw yarn can be obtained, for example, by heating an ingot made of the above-described raw material glass and having an average diameter of 100 mm to 1,700 to 2,300° C. in an electric furnace and stretching the ingot.

The shape of the raw yarn used in the present invention is not particularly limited, and examples thereof include glass ingots, monofilaments, and multifilaments having a maximum diameter of 2 mm.

The raw yarn diameter can be measured using a caliper (CD-20 manufactured by Mitutoyo Corporation) as shown in Examples described later.

### [3] Laser Source

In the production method of the present invention, laser light is used as a light source for causing the raw yarn to absorb the laser light to thermally soften the raw yarn. The laser light is suitable for the production method of the present invention because it has high parallelism of light beams, is easy to collect light and form parallel light fluxes, and provides a large output.

The laser source is not limited as long as it is a laser light source having a wavelength of 0.7 to 100 μm, and for example, a laser source selected from carbon dioxide, YAG, Nd/glass, Nd/vanadate, diode, fiber, disk, HeCd, copper vapor laser, iodine laser, argon laser, krypton laser, and chemical laser can be used.

Among them, a carbon dioxide laser having a wavelength of 10.6 μm, a YAG laser doped with Nd and having a wavelength of 1.06 μm, and a YVO laser are particularly preferable, and a carbon dioxide laser is more preferable because glass can be heated with high output in a short time.

### [4] Production Conditions of Glass Filament

In the production method of the present invention, the raw yarn described above is heated by irradiation with laser light having a wavelength of 0.7 to 100 μm while applying tension thereto, and softened and stretched.

In this case, the energy amount of the laser light to be absorbed by the raw yarn depends on the wavelength of the laser light, the diameter, density, and heat capacity of the raw yarn, a raw yarn feeding speed, a yarn speed, and laser light absorptivity, and thus cannot be generally defined, but the energy amount for heating the raw yarn to a temperature of 1,700° C. or higher, preferably 1,800° C. or higher, and more preferably 1,900° C. or higher is suitable.

The laser light absorption rate of the raw yarn is preferably 0.6 or more, and more preferably 0.9 or more from the viewpoint of heating efficiency. If the absorption rate is less than 0.6, the heating of the raw yarn is insufficient, which causes increased stretching tension, whereby yarn breakage may be apt to occur.

The stretching ratio is not particularly limited as long as a glass filament having a target average diameter is obtained, but is preferably 1,000 times or more, and more preferably 1,050 times or more.

### [5] Glass Filament Stretching Apparatus

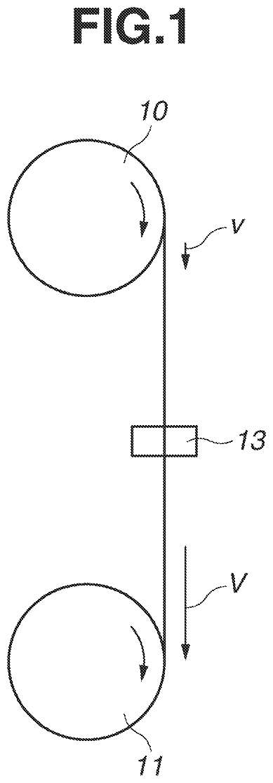

A glass filament stretching apparatus used in the production method of the present invention is not particularly limited, and for example, as illustrated in FIG. 1, it is possible to use an apparatus basically including: a supplying means 10 that can continuously supply a raw yarn 1 at a constant speed v; a winding means 11 that winds a filament at a speed V higher than the speed v; and an irradiating/heating means 13 that irradiates the traveling raw yarn 1 with laser light to heat the raw yarn in order to soften and stretch the raw yarn between the means 10, 11.

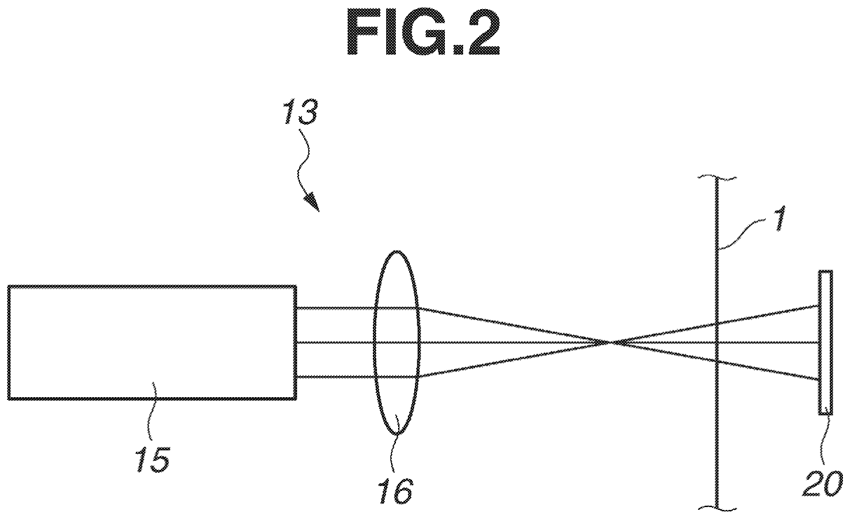

In the irradiating/heating means 13, as illustrated in FIG. 2, laser light 15 is condensed by a lens 16. In this case, the focal point of the laser light 15 is located on the left side of the raw yarn 1 in FIG. 2, but may be on the right side. Thus, by shifting the travelling position of the raw yarn 1 from the focal point of the laser light 15, the irradiation region of the laser light 15 can be widened. In FIG. 2, an air-cooled or water-cooled shielding plate 20 is provided on the further right side of the raw yarn 1, and the laser light 15 not absorbed by the raw yarn 1 is absorbed by the shielding plate 20. As a material constituting the shielding plate 20, a heat-resistant material such as a brick, and a metal whose surface is roughened and coated with a heat-resistant paint, and the like are suitable.

In addition to the above basic configuration, the glass filament stretching apparatus may include, for example, a raw yarn preheating means for preheating a raw yarn to eliminate a raw yarn winding defect, which is installed at the upstream portion of the irradiating/heating means, a guiding means slightly larger than a raw yarn diameter and for causing the raw yarn to pass therethrough for supplying in order to accurately supply the raw yarn to a laser irradiation spot, an oil agent treating means for bundling filaments to facilitate handling, which is installed at the downstream portion of the irradiating/heating means in a case of using the raw yarn in a multifilament state, a heat retaining means for retaining the heat of a fibrillated filament to suppress the occurrence of fiber breakage, which is installed at the downstream portion of the irradiating/heating means, and a protecting means (cover) for protecting a fibrillated fiber from disturbance influence, and the like, as necessary. In particular, in order to alleviate the influence of air resistance in winding, it is preferable to flow air or the like in the protecting means, and it is more preferable to flow air in a yarn flow direction.

### [6] Glass Filament

The glass filament obtained by the production method of the present invention described above has a hydroxyl group content of 300 ppm or less, but the hydroxyl group content is preferably 200 ppm or less, and more preferably 150 ppm or less.

The diameter of the obtained glass filament can be set to 1 to 20 μm depending on the above-mentioned stretching conditions, but is preferably 3 to 10 μm, and more preferably 3 to 7 μm.

The diameter of the filament can be measured using a scanning microscope (model: DS130-S) manufactured by TOPCON CORPORATION as shown in Examples described later. The diameter of the filament can also be calculated by the raw yarn diameter/√ stretching ratio according to the mass (volume) preservation law.

### EXAMPLES

Hereinafter, the present invention is described in more detail with reference to Examples and Comparative Examples, but the present invention is not limited to the following Examples.

Hereinafter, a raw yarn diameter and a glass filament diameter were measured as follows.

The raw yarn diameter was measured with a caliper (CD-20 manufactured by Mitutoyo Corporation).

The filament diameter after stretching was measured using a scanning microscope (model: DS130-S) manufactured by TOPCON CORPORATION. Consistency between the raw yarn diameter and the filament diameter calculated from a stretching ratio was confirmed, and in Examples, the converted values were shown.

The hydroxyl group content of the glass filament was measured by a diffusion reflection method IR.

### Example 1

A raw yarn made of a quartz glass ingot containing 99.9 wt % of SiO₂ and having a raw yarn diameter of 230 μm was irradiated with a carbon dioxide laser having a laser diameter of 3.5 mm, a wavelength of 10.6 μm, and an output of 22.2 W to be heated to a surface temperature of 2,208° C., and stretched 1,080 times at a raw yarn supply rate of 0.074 m/min and a filament winding rate of 80.0 m/min to obtain a glass filament having a diameter of 7 μm. The laser light absorption rate of the raw yarn was 0.9, and the hydroxyl group content of the filament obtained was 110 ppm.

### Example 2

The same raw yarn as that of Example 1 was irradiated with a carbon dioxide laser having a laser diameter of 3.5 mm, a wavelength of 10.6 μm, and an output of 20 W to be heated to a surface temperature of 2,090° C., and stretched 3,300 times at a raw yarn supply rate of 0.074 m/min and a filament winding rate of 224 m/min to obtain a glass filament having a diameter of 4 μm. The hydroxyl group content of the filament obtained was 135 ppm.

### Comparative Example 1

The same raw yarn as that of Example 1 was heated to a surface temperature of 2,010° C. by an oxyhydrogen flame burner using a mixed gas of oxygen and hydrogen and stretched 540 times to obtain a glass filament having an average diameter of 10 μm. The hydroxyl group content of this filament was 450 ppm.

Japanese Patent Application No. 2021-079801 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for producing a glass filament, the method comprising: irradiating a raw yarn containing 70 wt % or more of SiO₂ and having a raw yarn diameter of 100 to 2,000 μm with laser light having a wavelength of 0.7 to 100 μm to heat the raw yarn; and stretching the raw yarn to obtain the glass filament having a hydroxyl group (Si—OH) content of 300 ppm or less and a diameter of 1 to 20 μm.

2. The method for producing a glass filament according to claim 1, wherein a laser source of the laser light is selected from carbon dioxide, YAG, Nd/glass, Nd/vanadate, diode, fiber, disk, HeCd, copper vapor laser, iodine laser, argon laser, krypton laser, and chemical laser.

3. The method for producing a glass filament according to claim 1, wherein the raw yarn is made of quartz glass containing 99 wt % or more of SiO₂.

4. The method for producing a glass filament according to claim 3, wherein the raw yarn is irradiated with carbon dioxide laser to heat the raw yarn to a temperature of 1,700° C. or higher, and stretched.

5. The method for producing a glass filament according to claim 3, wherein the raw yarn is irradiated with carbon dioxide laser, and the raw yarn is heated and stretched at a ratio of 1000 times or more to obtain the glass filament having a diameter of 3 to 10 μm.
